(19) United States
(12) Patent Application Publication
(10) Pub. No.: US 2014/0215065 A1
(43) Pub. Date: Jul. 31, 2014

(54) MULTIPLE PROTOCOL COMMUNICATION SYSTEM FOR APPLIANCES

(71) Applicant: ELECTROLUX HOME PRODUCTS, INC., Charlotte, NC (US)

(72) Inventor: Gary W. Fisher, Charlotte, NC (US)

(73) Assignee: ELECTROLUX HOME PRODUCTS, INC., Charlotte, NC (US)

(21) Appl. No.: 14/244,492

(22) Filed: Apr. 3, 2014

Related U.S. Application Data
(63) Continuation of application No. PCT/US2012/058948, filed on Oct. 5, 2012.
(60) Provisional application No. 61/544,851, filed on Oct. 7, 2011.

(51) Int. Cl. H04L 12/28

(52) U.S. Cl. CPC H04L 12/2816
USPC 709/224

(57) ABSTRACT

A communication apparatus is provided for facilitating communication between household appliances, such as kitchen and laundry appliances, and a network. A receiver device is configured to receive communication data from an appliance disposed at a site. A processor device is in communication with the receiver device and is configured to analyze the communication data to determine an appliance identification data element and an associated address of a destination in the network corresponding thereto. A transmitter device is in communication with the processor device and the network, and is configured to transmit the communication data to the destination address in the network determined by the processor device. An associated method is also provided.

### CROSS-REFERENCE TO RELATED APPLICATIONS

This application is a continuation of International Application No. PCT/US2012/058948, filed Oct. 5, 2012, which International Application was published by the International Bureau in English on Apr. 11, 2013, and claims priority to U.S. Provisional Application No. 61/544,851, filed Oct. 7, 2011, which are incorporated herein by reference in their entirety and for all purposes.

### FIELD OF THE DISCLOSURE

This disclosure generally relates to kitchen and laundry appliances, and this disclosure more particularly relates to a multiple protocol communication system for facilitating communication between such appliances and a network.

### BACKGROUND OF THE DISCLOSURE

Some modern laundry and/or kitchen appliances may be provided with appropriate devices and/or functionality for providing, for example, operational, status, or error information associated therewith that may be useful to the user, may facilitate servicing via the manufacturer or service center, and/or may assist the manufacturer in determining diagnostic or life data associated with the particular appliance. However, each manufacturer may have their own requirements as to the information originating from their appliances, as well as how this information is processed, transmitted, and otherwise implemented, and it may be inconvenient to capture, transmit, or otherwise utilize this information from these appliances, if different appliances from different manufacturers with different communication protocols are combined at a particular site.

### SUMMARY OF THE DISCLOSURE

In recognition of the above shortcomings, one aspect of this disclosure is the provision of a communication apparatus for facilitating communication between household appliances, such as kitchen and laundry appliances, and a network. A receiver device is configured to receive communication data from an appliance disposed at a site. A processor device is in communication with the receiver device and is configured to analyze the communication data to determine an appliance identification data element and an associated address of a destination in the network corresponding thereto. A transmitter device is in communication with the processor device and the network, and is configured to transmit the communication data to the destination address in the network determined by the processor device. An associated method is also provided.

The foregoing presents a simplified summary in order to provide a basic understanding of some aspects of this disclosure. This summary is not an extensive overview and is not intended to identify key or critical elements of the disclosure or to delineate the scope of the disclosure. The purpose of this section is to present some concepts of the disclosure in a simplified form as a prelude to the more detailed description that is presented later. Other aspects of this disclosure will become apparent from the following.

### BRIEF DESCRIPTION OF THE DRAWING

Having thus described the disclosure in general terms, reference will now be made to the accompanying drawings, which are not necessarily drawn to scale, and wherein:

FIG. 1 schematically shows an exemplary communication system for appliances, in accordance with one aspect of the present disclosure;

FIG. 2 schematically shows an exemplary communication system for appliances, in accordance with another aspect of the present disclosure; and

FIG. 3 schematically shows an exemplary communication data string and correlating lookup table implemented in a communication system for appliances, in accordance with one aspect of the present disclosure.

### DETAILED DESCRIPTION

Exemplary embodiments of this disclosure are described below and illustrated in the accompanying figure, in which like numerals refer to like parts. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention.

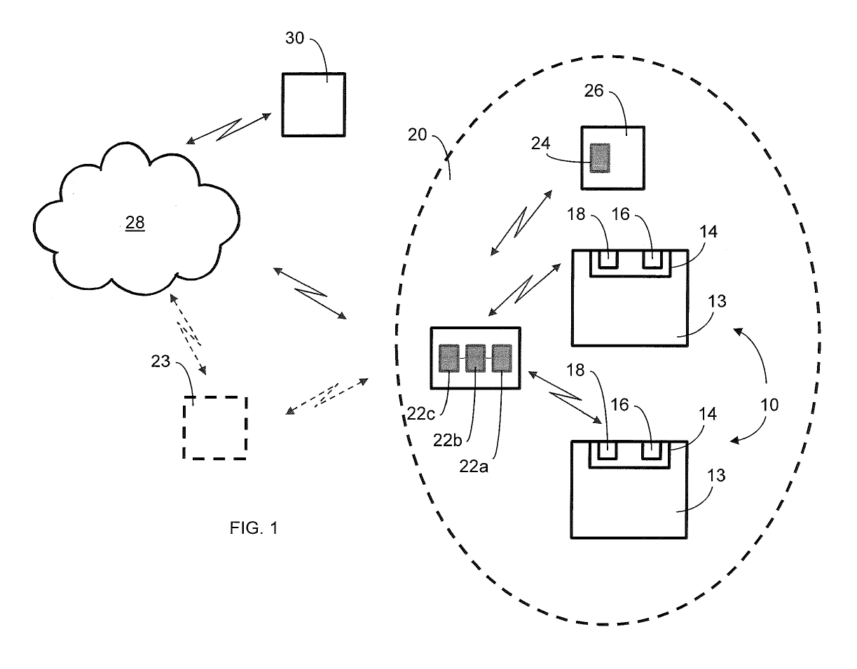

Referring now in greater detail to the drawing, FIG. 1 schematically shows one or more appliances 10 that are each configured to at least transmit communication data, either wirelessly or by hardwire or other wire line. In accordance with one embodiment of the disclosure, the appliances 10 may be kitchen and/or laundry appliances, although other types of appliances are also within the scope of this disclosure. The kitchen appliance(s) may be one or more of an oven, stove, range, warmer, toaster, microwave oven, dishwasher, refrigerator, freezer, icemaker, and coffee maker. The laundry appliance(s) may be one or more of a laundry washer and/or a laundry dryer. Other types of appliances are also within the scope of the disclosure. For example, one such other type of appliance may be a smart grid meter (or “smart meter”) which may be implemented in conjunction with an appliance installation.

Each of the kitchen/laundry appliances 10 typically includes a housing 13, operational components mounted within and carried by the housing for performing the operational functions of the appliance, and a control system 14 at least partially mounted within and carried by the housing. The control system 14 is in communication with the operational components for receiving information from and/or providing information to the operational components for coordinating the operational functions of the appliance 10. The type and number of the operational components included in the appliance 10 will depend upon the functionality of the appliance. For example, the operational components of a kitchen oven, range or food warmer may include one or more heating elements for heating a chamber of the appliance that is accessible by a door, and one or more temperature sensors for measuring the temperature within the chamber. As another example, a laundry appliance (e.g., a washing or drying machine) typically includes a tub portion, supported within the housing, in which laundry may be placed for washing and/or drying. The tub portion may also define an access opening that may be located at an upper surface or a forward surface of the appliance. A door assembly may be pivotably engaged with the tub portion or housing so as to selectively permit access to the interior of the tub portion via the access opening. A washing or drying drum is rotatably disposed within the tub portion of the respective washing and drying appliance for agitating or spinning the laundry during the washing or drying process. The laundry appliance includes particular operational components (e.g., pumps, valves, motors, etc.) for performing the operational functions thereof.

The control system 14 may be embodied in any suitable manner, such as in software, firmware and/or hardware modules. For example, the control system 14 may be in the form of one or more computer or computer-like devices (which may include one or more appropriate input and output devices, processors, memories and software modules) for controlling operational components of the appliance by virtue of receiving data from and/or providing data (e.g., instructions) to respective operational components. The control system 14 may include or otherwise be associated with a user interface 16. The user interface 16 may be configured for being directly interacted with by the user of the appliance 10, so that the user may initiate, terminate, and otherwise at least partially control operation of the appliance while the user is manipulating the user input devices of the user interface. In this regard, the user interface 16 may include one or more physical, manually-actuatable buttons and/or dials mounted to and accessible to a user at a control panel of the appliance 10, and/or one or more audio devices, such as buzzers or speakers. The control panel may be located at a front or top face of the appliance 10, or in any other suitable location.

In addition or alternatively, the user interface 16 of each appliance 10 may be in the form of, or include, a touchscreen user interface. The touchscreen user interface may be associated with one or more software, firmware and/or hardware modules that are operative for causing the touchscreen user interface to display icons, and to be responsive to touches by a user, so that the user may control operation of, and access information about, the appliance 10 by way of the touchscreen user interface. A user may interact with the touchscreen user interface by way of a display screen associated therewith. The display screen may comprise a liquid crystal display (LCD) or other display device capable of providing graphics/images to the user while the user is in opposing face-to-face relation with the display screen. The touchscreen user interface may be configured to present a plurality of virtual buttons or icons on the display screen. Each icon may be configured to include graphics and/or text (i.e., a string of alphanumeric characters) to provide the user with an indicia of a position on, or area of, the display screen with which the user may interact (i.e., touch) in order to select the corresponding icon. In some instances, the icon may have the appearance on the display screen of a physical button (i.e., via three-dimensional graphics imaging), while in other instances the icon may only appear as text, a graphic, or combinations thereof on the display screen.

Aspects of the present disclosure associated with such appliances 10 are directed to a multiple protocol communication system for facilitating communication between the appliances and a network, as disclosed in further detail herein. In addressing such aspects, each of the appliances 10 may be configured to include a communication adapter 18 (e.g., a local communication apparatus) associated therewith. For each of the appliances 10, the communication adapter 18 may be an integral part of the control system 14 of the appliance 10, or the communication adapter 18 may be retrofitted to the control system of an existing appliance. In one retrofit option, the communication adapter 18 may be a peripheral device that is connected to a suitable interface of the control system 14. Examples of suitable interfaces may include, but are not limited to, universal serial bus (USB) ports, serial ports and parallel ports. The communication adapter 18, or at least a substantial portion thereof; may be contained within the appliance's housing 13. For example, an antenna associated with a wireless communication adapter 18 may project from the appliance's housing 13. In some instances, the communication adapter 18 includes and/or may be more generally referred to as a local transceiver, which may be interchanged with a transmitter and/or receiver, or any other suitable communication device. In other instances, the communication adapter 18 may at least comprise a transmitter configured to transmit communication data, intended for the network, from the appliance 10.

Whereas the communication adapters 18 may be characterized as being part of, or otherwise closely associated with, the respective appliances 10, at the same time the communication adapters may also be characterized as being part of a local area network 20 whether configured for wired or wireless communication. In accordance with one aspect of the present disclosure, the local area network 20 may further includes at least one router 22 (e.g., an intermediate communication apparatus) for communicating with the communication adapters 18. If configured for wireless communication, the router 22 may be in sufficiently close proximity to the appliances 10 to be in good wireless communication with the communication adapters 18 associated therewith.

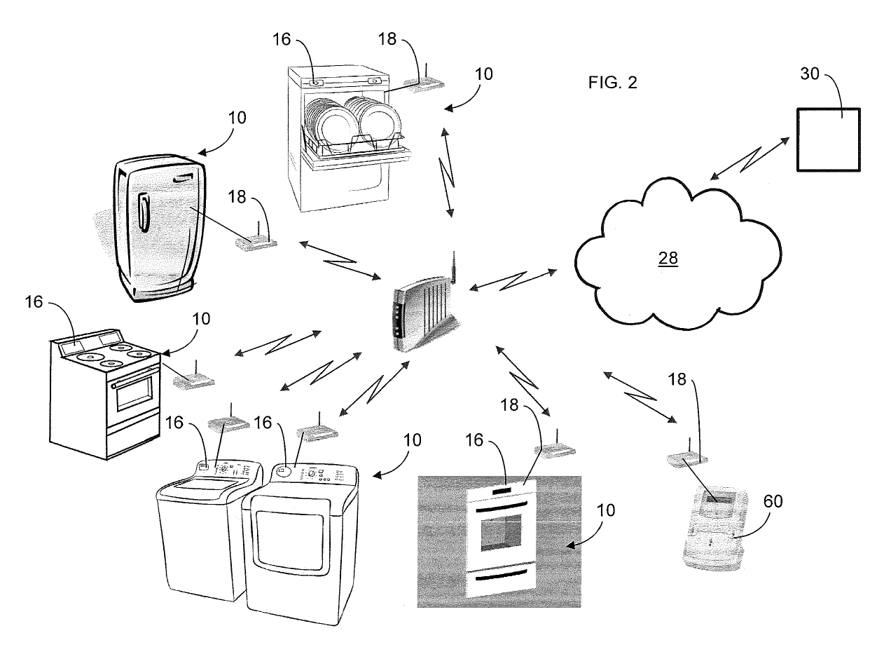

Otherwise, the router 22 may be disposed at the site at which the appliances are disposed so as to be in communication with the communication adapters 18 associated therewith in a wired or wire line configuration. The router 22 includes and/or may be more generally referred to as an intermediate transceiver, which may be interchanged with a transmitter and/or receiver, or any other suitable communication device. In various aspects, the communication adapter 10 may be configured to wirelessly communicate the communication data with the router 22, for example, through a cellular data network (3G or 4G), or via WiFi. In other aspects, the communication adapter 18 may be configured to communicate such data by hardwire or wire line through, for example, a suitable interface including, but not limited to, universal serial bus (USB) ports, serial ports, parallel ports, an Ethernet connection, or other dedicated wire line.

Whereas only a single local area network 20/router 22 and two appliances 10 are shown in FIG. 1, other aspects of the communication system may include numerous of the local area networks 20/numerous of the routers 22/numerous of the appliances 10 (see, e.g., FIG. 2). Each of the local area networks 20 may optionally include other suitable devices, such as a communication adapter 24 of a local computer 26. In one example, the local computer 26 may be operative for providing or otherwise initiating notifications about the appliances 10 and/or the communication data originating therefrom and providing such notifications in an appropriate form, and/or for serving as a repository for data associated with the appliances 10, the local area network 20, and/or the router 22, and/or for providing information about one or more of the appliances 10 and/or the communication data originating therefrom. For example, in some instances, the user, by way of the local computer 26, may be able to access or otherwise monitor various aspects of the appliance 10, such as operational modes, statuses, setpoints, operational or delay times, operation history and historical setpoints, and the like.

For the local area network 20 illustrated in FIG. 1, the router 22 may be in direct communication with a network 28 that forms part of the communication system of the present disclosure. The network 28 may optionally be referred to as an overarching network 28. The overarching network 28 may include one or more suitable communication networks, such as, but not limited to, the Internet, cable television networks, cellular data networks, and/or the public switched telephone network. In accordance with particular aspects, the overarching network 28 comprises the Internet, and a suitable connection between the router 22 and the Internet may be at least partially provided by a cable modem, Digital Subscriber Line modem, by one or more cellular data networks (3G or 4G), or by any other suitable device(s). In one example, the router 22 is operative so that the local area network 20 is a Wi-Fi wireless local area network, and the router 22 and communication adapters 18, 24 may operate in accordance with the ZigBee standard. However, any suitable router 22 and communication adapters 18, 24 may be used, and the local area network may be in any other suitable form, such as by not being wireless (e.g., it may be a wired network, a fiber optic network, and/or any other suitable network).

In other aspects, however, the router 22 may be configured to be in indirect communication with the overarching network 28, for example, through a site router 23 associated with the site at which the appliances 10 are disposed. In such instances, where the router 22 is indirectly in communication with the network 28, the router 22 may thus form, for example, in conjunction with the appliances 10, an appliance-specific network for the particular site. The formation of an appliance-specific network for the particular site may be beneficial, for example, in providing a particular and dedicated communication apparatus for receiving communication data from the appliances, thereby removing the need to accommodate variations between site routers 23 (i.e., variations between commercially available routers available for consumer use) and/or location constraints and variations with respect thereto. Accordingly, the router 22 may be configured so as to facilitate communication with the site router 23 regardless of the variations which may be apparent among such commercially available routers.

An example of some aspects of a communication system according to the present disclosure involving a representative one of the appliances 10 will be described in the following. Operation of a representative appliance 10 may be conducted via the appliance user interface in a manner so that the controller or the appliance's control system 14 follows an instruction or a set of instructions for causing the appliance to carry out an operation or a series of operations. In addition to following the instruction or instructions, the controller or the control system 14 may be configured to monitor operational information (e.g., operational states) associated with the appliance 10. In accordance with some aspects, the controller or the control system 14 (or the controller in combination with another suitable computer or computer-like device) is operative, by way of appropriate software, firmware and/or hardware modules, for providing data about such instruction(s) and/or operational state(s) and/or statuses and/or errors, along with other suitable communication data, such as data at least partially identifying the appliance (e.g., a manufacturer identity, a brand identity, a model identity, and/or an Internet Protocol address assigned to the appliance) and the destination for this data (e.g., another Internet Protocol address in the network 28 that identifies the destination for the data such as, for example, a particular manufacturer or service center site, and, in some instances, the transport protocol such as UDP or TCP/IP designated by the appliance and/or the destination for the particular appliance), to the associated communication adapter 18 for transmission to the destination (e.g., manufacturer or service center site associated with the appliance). The router 22 receives the communication data transmitted from the communication adapter 18, via a receiver device 22a associated therewith. The communication data, in turn, is processes by a processor device 22b associated with the router 22 and configured to be in communication with the receiver device 22a thereof, to determine and identify the appropriate destination in the network and transport protocol associated therewith. A transmitter device 22c associated with the router 22 and configured to be in communication with the processor device 22b thereof is then configured to transmit the communication data in the appropriate format (i.e., with respect to the payload) to the appropriate manufacturer and/or service center site 30 associated with the identified destination.

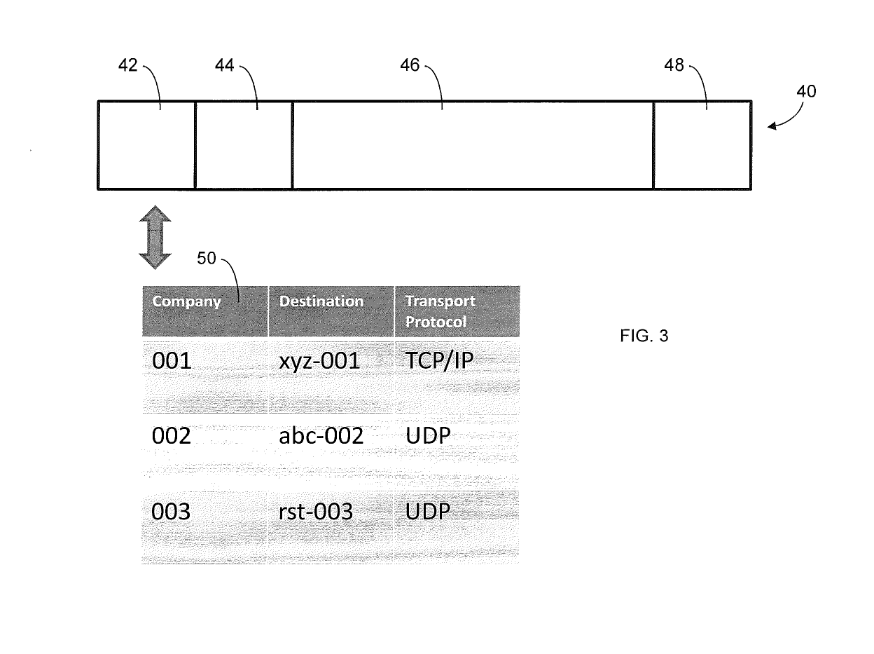

More particularly, according to particular aspects of the present disclosure, the communication data originating from the appliance may be encrypted (i.e., using a packet-level encryption scheme), in whole or in part, as necessary or desired. Further, this communication data 40 (see, e.g., FIG. 3) originating from the appliance may include a particular appliance identification data element 42 at least partially identifying the appliance (e.g., a manufacturer identity, a brand identity, and/or a model identity as realized, for instance, by a unique alphanumeric character or series of characters). An appropriately configured processor device 22b associated with the router 22 may thus be configured to decrypt all or part of the communication data, as necessary or desired. In any instance, the processor device 22b may be further configured to determine, from the appliance identification data element 42, the intended destination 30 for this data (e.g., an Internet Protocol address in the network 28 that identifies the destination for the data such as, for example, a particular manufacturer or service center site, and the transport protocol such as UDP or TCP/IP designated by the appliance and/or the destination associated with the particular appliance, as realized, for instance, through a standard routing data structure). This determination by the processor device 22b may be made by the processor device utilizing at least one lookup table 50 (see, e.g. FIG. 3), or the like, that is stored in or otherwise associated with a database and includes correlated information about the about the appliance identification data element 42 as provided by the particular appliance as it relates to a particular destination in the network for the communication data, as well as the transport protocol 44 required therefor. For example, if the communication data 40 relates to error codes, operational codes, or the like, a TCP/IP transport protocol may be preferred, whereas for substantially continuous data such as that obtained through operation/function monitoring of the appliance, a UDP transport protocol may be preferred. The transport protocol may be included with the communication data, or otherwise be associated with the lookup table or database in relation to the appliance identification data element (see, e.g., FIG. 3). In this manner, the router 22 may be configured to communicate with many different type, brand, manufacturer, and/or model variants of various appliances 10 arranged as part of the local area network.

In some aspects, the router 22 or at least the processor device 22b thereof may be configured to recognize a particular manufacturer associate with the appliance identification data element and to implement the required parameters associated therewith as defaults to transmit the communication data 40 to the corresponding required destination 30 in the network. If a new appliance originating, for example, from a different manufacturer, is introduced to the site in addition to or as a replacement for an existing appliance originating from the default manufacturer, the new appliance may be commissioned or otherwise introduced to the router 22/processor device thereof through implementation, for instance, of a WiFi Protected Setup (WPS) protocol/procedure. In other instances, the different manufacturer associated with the new/unknown appliance may be determined by correlating the appliance identification data element with resources available via an external source, such as the overarching network 28, and the required parameters associated therewith then implemented to transmit the communication data to the corresponding required destination in the network. If the information associated with the different manufacturer is not included in the lookup table or associated database, the lookup table and associated database may be dynamically updated with this information. In other instances, this information may be manually introduced to the router 22 by the user (i.e., as long as the router 22 supports the WPS protocol) or the router 22 may automatically update with this information upon subsequent power up. In other aspects, the communication data received from one appliance in the local area network 20 may be destined for another appliance within that network. For example, in some instances, two appliances from a particular manufacturer may be configured to be interoperable (i.e., a washer and dryer pair) through communication therebetween. In such instances, the communication data originating from one of those appliances may be directed, via the corresponding communication adapter 18, to the router 22/processor device 22b, wherein the appliance identification data element associated therewith may be determined to be, for example, an interoperability code specifying a related appliance also in communication with the local area network 20. In such instances, the router 22/processor device may merely route the communication data to the related appliance via the transmitter device and the communication adapter 18 associated with that appliance.

The communication data 40 gathered and transmitted by the controller or the control system 14 of the appliance 10 may vary considerably depending on many different factors such as, for example, the manufacturer of the appliance, the model series or family of the appliance, the operational state of the appliance, the installation environment of the appliance, the enabled or disabled options with respect to the appliance, or the like. Accordingly, in some aspects, one or more substantive portions of the communication data, or “payload,” (See, e.g., element 46 in FIG. 3) that may be gathered and transmitted to the address on the network (i.e., representative of the manufacturer of the appliance or a particular designated service center) can include, but is not limited to, for example, an error code currently displayed by the appliance, a date and/or time stamp of the currently-displayed error code, an operational mode of the appliance when the error occurred, particular setpoints of the appliance when the error occurred, actual operational conditions of the appliance when the error occurred, a particular number of previous error codes stored in a memory associated with the appliance, a particular number of the last key selections by the user on the appliance user interface, a particular number of the last key selections by the user on the appliance user interface prior to the error code, the status of an indicator associated with the appliance, and/or the current operational status of various aspects of the appliance. Because the appliance identification data element can be associated, by the router 22, with the intended destination 30 for this data (e.g., an Internet Protocol address in the network 28 that identifies the destination for the data such as, for example, a particular manufacturer or service center site, and the transport protocol such as UDP or TCP/IP designated by the appliance and/or the destination associated with the particular appliance, as realized, for instance, through a standard routing data structure), the payload can be verified via a verification element (see, e.g., element 48 in FIG. 3), such as a checksum, and then directed to that intended destination without concern for or regardless of the payload content. In this manner, the various and/or multiple protocols used by various appliance manufacturers to gather particular information from its appliances may be supported by a single communication system according to aspects of the present disclosure, provided that such appliance identification data elements and associated information are provided by such manufacturers or are otherwise discernible from the communication data originating from the appliances thereof.

In one aspect of this disclosure, the user may be considered to be a person using the appliances 10 for the appliances' intended purposes. However, numerous variations are within the scope of this disclosure. For example, other embodiments of this disclosure may include noted variations and variations that will be apparent to one of ordinary skill in the art. In accordance with another aspect of this disclosure, the communication data transmitted to the intended destination may be analyzed, monitored, or otherwise used by a person providing appliance repair or set-up services, or any other suitable services, and this service provider may use the communication system to address any issues that may be apparent therefrom, such as addressing particular errors, malfunctions, or faults.

In accordance with another aspect of this disclosure, cloud computing services may be incorporated into the communication system. For example, one or more of the operabilities provided by the overarching network 28 may be provided by way of cloud computing services. As other examples, numerous other features may be incorporated into or substituted for respective features of the communication system of this disclosure. For example, a variety of electronic commerce features may be incorporated into or otherwise associated with or provided in response to the communication data for facilitating smart grid implementation in conjunction, for instance, with a smart meter 60 installed at the site and communicable with the local area network 20 via its own communication interface 18 (see, e.g., FIG. 2).

Although the above disclosure has been presented in the context of exemplary embodiments, it is to be understood that modifications and variations may be utilized without departing from the spirit and scope of the invention, as those skilled in the art will readily understand. For example, the various configurations and functionality associated with router 22 disclosed herein may be implemented in commercially available routers in some instances, and under particular conditions such as, for instance, that such commercially available router be configured to support the WiFi Protected Setup (WPS) protocol/procedure.

In another instance, the communication data received from the appliances may be analyzed, monitored, or otherwise used at the destination site for other ecommerce purposes. For example, the communication data and/or the router 22 may have a particular user's information associated therewith, such as a physical address or email address, and the communication data may include operational milestones associated with an appliance. Such an operational milestone could include, for example, a filter replacement interval or a warranty period. In such instances, a communication could be sent from the destination site to the particular user to notify the user of the milestone and to offer appropriate goods or services to the user. Continuing with the noted example, the user could be provided, for instance, with an Internet link to purchase a replacement filter or with an offer for an extended warranty. One skilled in the art will appreciate, however, that such e-commerce aspects associated with this scheme may have significant variation and scope. For example, the communication data may be monitored and analyzed by the destination site to determine whether the user is missing a certain appliance or to determine whether new or other appliances are available which have particular functions most often used by the user. In such instances, advertising and/or purchasing information regarding such appliances may be directed to the user. Such modifications and variations are considered to be within the purview and scope of the appended claims and their equivalents.

1. A communication apparatus for facilitating communication between household appliances and a network, comprising:
a receiver device configured to receive communication data from an appliance disposed at a site;
a processor device in communication with the receiver device and configured to analyze the communication data to determine an appliance identification data element and an associated address of a destination in the network corresponding thereto; and
a transmitter device in communication with the processor device and the network, and configured to transmit the communication data to the destination address in the network determined by the processor device.

2. The apparatus according to claim 1, wherein the appliance identification data element comprises one of a manufacturer identity, a brand identity, and a model identity for the appliance.

3. The apparatus according to claim 1, wherein the processor device is configured to compare the appliance identification data element to one of a look-up table and a database, each of the lookup table and the database having appliance identification data elements associated with corresponding network destination addresses, to determine the network destination address associated therewith.

4. The apparatus according to claim 3, wherein the network destination address comprises another appliance disposed at the site, and the communication data comprises interoperability data.

5. The apparatus according to claim 1, wherein the transmitter device is configured to indirectly communicate with the network via a site router disposed at the site.

6. The apparatus according to claim 1, wherein the processor device is configured to analyze the communication data to determine a transport protocol associated therewith, the transport protocol comprising one of a UDP protocol and a TCP/IP protocol.

7. The apparatus according to claim 1, wherein the processor device is configured to validate the communication data prior to the communication data being transmitted by the transmitter device.

8. The apparatus according to claim 1, wherein the network destination address is an Internet Protocol address in the network and the network comprises the Internet.

9. The apparatus according to claim 1, wherein a processor device is configured to commission a new appliance by analyzing the communication data using a WiFi Protected Setup protocol to determine the appliance identification data element, the associated address of a destination in the network corresponding thereto, and a transport protocol for the communication data associated therewith.

10. The apparatus according to claim 1, wherein the communication data comprises a payload including one of an error code currently displayed by the appliance, a date and/or time stamp of the currently-displayed error code, an operational mode of the appliance when a corresponding error occurred, particular setpoints of the appliance when the error occurred, actual operational conditions of the appliance when the error occurred, a particular number of previous error codes stored in a memory associated with the appliance, a particular number of the last key selections by the user on the appliance user interface, a particular number of the last key selections by the user on the appliance user interface prior to the error code, the status of an indicator associated with the appliance, and the current operational status of various aspects of the appliance.

11. The apparatus according to claim 10, wherein the transmitter device is configured to transmit the communication data, including at least a portion of the payload, to the destination address in the network determined by the processor device

12. A method for facilitating communication between household appliances and a network, comprising:
receiving communication data with a receiver device from an appliance disposed at a site;
analyzing the communication data with a processor device to determine an appliance identification data element and an associated address of a destination in the network corresponding thereto; and
transmitting the communication data with a transmitter device to the destination address in the network determined by the processor device.

13. The method according to claim 12, wherein analyzing the communication data comprises analyzing the communication data to determine an appliance identification data element comprising one of a manufacturer identity, a brand identity, and a model identity for the appliance.

14. The method according to claim 12, further comprising comparing the appliance identification data element to one of a look-up table and a database, using the processor device, each of the look-up table and the database having appliance identification data elements associated with corresponding network destination addresses, to determine the network destination address associated therewith.

15. The method according to claim 14, wherein the network destination address comprises another appliance disposed at the site, and transmitting the communication data comprises transmitting the communication data, including interoperability data, to the other appliance.

16. The method according to claim 12, further comprising indirectly communicating with the network, using the transmitter device, via a site router disposed at the site.

17. The method according to claim 12, wherein analyzing the communication data comprises analyzing the communication data to determine a transport protocol associated therewith, the transport protocol comprising one of a UDP protocol and a TCP/IP protocol.

18. The method according to claim 12, further comprising validating the communication data, with the processor device, prior to the communication data being transmitted by the transmitter device.

19. The method according to claim 12, wherein the network destination address is an Internet Protocol address in the network and transmitting the communication data comprises transmitting the communication data to the Internet Protocol address on the Internet.

20. The method according to claim 12, further comprising commissioning a new appliance by analyzing the communication data, with the processor device, using a WiFi Protected Setup protocol to determine the appliance identification data element, the associated address of a destination in the network corresponding thereto, and a transport protocol for the communication data associated therewith.

21. The method according to claim 12, wherein receiving communication data comprises receiving communication data comprising a payload including one of an error code currently displayed by the appliance, a date and/or time stamp of the currently-displayed error code, an operational mode of the appliance when a corresponding error occurred, particular setpoints of the appliance when the error occurred, actual operational conditions of the appliance when the error occurred, a particular number of previous error codes stored in a memory associated with the appliance, a particular number of the last key selections by the user on the appliance user interface, a particular number of the last key selections by the user on the appliance user interface prior to the error code, the status of an indicator associated with the appliance, and the current operational status of various aspects of the appliance.

22. The method according to claim 21, wherein transmitting the communication data comprises transmitting the communication data, including at least a portion of the payload, to the destination address in the network determined by the processor device.

23. A computer program product for facilitating communication between household appliances and a network, the computer program product comprising at least one non transitory computer readable storage medium having computer-readable program code stored thereon, the computer-readable program code comprising:
program code for receiving communication data with a receiver device from an appliance disposed at a site;
program code for analyzing the communication data with a processor device to determine an appliance identification data element and an associated address of a destination in the network corresponding thereto; and
program code for transmitting the communication data with a transmitter device to the destination address in the network determined by the processor device.

24. The computer program product according to claim 23, wherein the program code for analyzing the communication data comprises program code for analyzing the communication data to determine an appliance identification data element comprising one of a manufacturer identity, a brand identity, and a model identity for the appliance.

25. The computer program product according to claim 23, further comprising program code for comparing the appliance identification data element to one of a lookup table and a database, using the processor device, each of the look-up table and the database having appliance identification data elements associated with corresponding network destination addresses, to determine the network destination address associated therewith.

26. The computer program product according to claim 25, wherein the network destination address comprises another appliance disposed at the site, and the program code for transmitting the communication data comprises program code for transmitting the communication data, including interoperability data, to the other appliance.

27. The computer program product according to claim 23, further comprising program code for indirectly communicating with the network, using the transmitter device, via a site router disposed at the site.

28. The computer program product according to claim 23, wherein the program code for analyzing the communication data comprises program code for analyzing the communication data to determine a transport protocol associated therewith, the transport protocol comprising one of a UDP protocol and a TCP/IP protocol.

29. The computer program product according to claim 23, further comprising program code for validating the communication data, with the processor device, prior to the communication data being transmitted by the transmitter device.

30. The computer program product according to claim 23, wherein the network destination address is an Internet Protocol address in the network and the program code for transmitting the communication data comprises program code for transmitting the communication data to the Internet Protocol address on the Internet.

31. The computer program product according to claim 23, further comprising program code for commissioning a new appliance by analyzing the communication data, with the processor device, using a WiFi Protected Setup protocol to determine the appliance identification data element, the associated address of a destination in the network corresponding thereto, and a transport protocol for the communication data associated therewith.

32. The computer program product according to claim 23, wherein the program code for receiving communication data comprises program code for receiving communication data comprising a payload including one of an error code currently displayed by the appliance, a date and/or time stamp of the currently-displayed error code, an operational mode of the appliance when a corresponding error occurred, particular setpoints of the appliance when the error occurred, actual operational conditions of the appliance when the error occurred, a particular number of previous error codes stored in a memory associated with the appliance, a particular number of the last key selections by the user on the appliance user interface, a particular number of the last key selections by the user on the appliance user interface prior to the error code, the status of an indicator associated with the appliance, and the current operational status of various aspects of the appliance.

33. The computer program product according to claim 32, wherein the program code for transmitting the communication data comprises program code for transmitting the communication data, including at least a portion of the payload, to the destination address in the network determined by the processor device.
